(19) United States
(12) Patent Application Publication
(10) Pub. No.: US 2012/0167644 A1
(43) Pub. Date: Jul. 5, 2012

(54) DELAYED EGRESS PADDLE ALARM DOOR LOCK

(76) Inventor: Mark J. BERGER, New York, NY (US)

(21) Appl. No.: 13/342,395

(22) Filed: Jan. 3, 2012

Related U.S. Application Data
(60) Provisional application No. 61/429,022, filed on Dec. 31, 2010.

(51) Int. Cl. E05B 65/06; E05B 47/00

(52) U.S. Cl. 70/144; 70/141

(57) ABSTRACT

A delayed egress paddle door lock system operable with a door that is pivotally mounted in a door frame, including
a. a main lock module with a lock bolt,
b. a push paddle for driving the lock bolt from its locked position to its unlocked position, and
c. a delayed egress lock module mountable on the door and including, a locking element having a restraining position where it engages a restraining element on the frame and restrains the door from being opened, and a control member including a timer, adapted to sense when the push paddle has been pushed, move the locking element to its restraining position, activate the timer for a predetermined time delay period while the locking element is in its restraining position, and afterward to move the locking element to its release position, whereby the door becomes openable from the push paddle.

### RELATED PATENT APPLICATION

This application claims priority under 35 U.S.C. §119, 120 based upon applicant's Provisional Patent Application Ser. No. 61/429,022, filing date of Dec. 31, 2011.

### I. BACKGROUND

1. Field of the Invention

This invention is in the field of security devices for exit doors, and more particularly to a security door lock with a push paddle release bar and a delayed egress control feature.

2. Background and Prior Art

Incidences of forcible entry or exit from public and commercial buildings have increased dramatically during the recent past. Accordingly, the demand for reliable security systems has increased sharply. Public awareness of rising crime rates, increased attention to crime prevention efforts, and insurance considerations give further impetus to the development of dependable security systems.

For many security doors the preferred lock systems include dead bolt locks where a strong bolt penetrates the door casing and projects deeply into a port defined through a door frame. Even with the use of a pry bar, the end of the elongated bolt cannot easily be disengaged from its port. Typically, such a dead bolt lock system includes a paddle arm in a casing mounted to the interior of the door, the paddle arm being pushable outwardly toward the door or downwardly, to mechanically release or drive an elongated latch bolt normally biased to a latched condition. One such paddle arm lock is shown in U.S. Pat. No. 5,139,292 and incorporated herein by reference. It is known for a paddle arm lock to be coupled with an alarm system for alerting persons in the building that the door has been unlocked.

A significant recent problem involves the abuse of emergency exits in commercial or public facilities. Since these emergency or panic exit doors provide rapid egress for individuals from a building, thieves and other wrongdoers have been known to use these exits as convenient escape routes. There are circumstances where building owners or managers would prefer to deny immediate availability of the exit; however, to permanently encumber an emergency exit door is unacceptable in consideration of genuine emergencies and is often prohibited by law.

As previously mentioned, some prior locks attempt to solve the problem by sounding an alarm when the door is unlocked. Unfortunately, such alarms generally fail to provide sufficient reaction time for authorized personnel to verify the emergency before opening the door. Furthermore, it is often desirable to maintain the secured status of emergency exits in some operating environments until authorized personnel can assist the evacuees. For example, it is desirable to maintain the security of hospital emergency exits to prevent patients from wandering out of emergency exits without proper assistance.

In many modern buildings the National Fire Protection Association (NFPA) and similar building code authorities permit the installation of delayed egress systems to prevent shoplifting. Such systems delay exit door activation after paddle depression for a brief period of time, generally fifteen to thirty seconds. An audible signal is generated during the delay period that allows security personal to assess the emergency situation and stop people from using the exits fraudulently.

National standards of performance for delayed egress locks have already been established, as those found in ANSI/BHMA Section 156.24 which establish operating parameters for timed release or delayed egress door locks that are different from other normal types of door locks.

Conventional delay mechanisms can be grouped as either primary or auxiliary lock delays. In other words, the delay mechanism is either (a) combined with the primary lock latch to form an unitary system, or (b) physically separated from the primary latch but combined with an auxiliary lock latch of some type.

Known prior art devices using primary lock delays are seen in U.S. Pat. Nos. 4,328,985, 5,011,199, 5,035,450, 5,085,475 and 5,746,458. Most of these emergency exit devices combine a paddle door lock with an internal delaying mechanism directly associated with the door latchbolt. Normally, the paddle lock housing contains an internal linkage that connects, the latchbolt to the paddle. The linkage moves the latchbolts in response to paddle depression to release the exit door. In the above referenced patents the delay mechanism is generally interposed between the paddle and the latchbolts to prevent the immediate opening of the exit door.

Known prior art devices employing auxiliary delay latch systems are seen in U.S. Pat. Nos. 4,314,722 and 4,540,208. In both of these systems the time delay mechanism controls an auxiliary lock that prevents door opening even though the primary lock has opened. However, these systems both employ control mechanisms at least partly dependent upon hydraulic fluids. One problem with fluid control devices is that they are often susceptible to variable operation during extreme temperature conditions, which could easily become problematic during a fire. Other prior art devices of general relevance include U.S. Pat. Nos. 4,682,801 and 4,871,204.

Hence, it is desirable to provide a security locking system that positively locks a door against undesired intrusions and that also provides a delay mechanism to overcome the disadvantages associated with other delay mechanisms. An ideal delayed egress system should be easily retrofittable to exiting paddle arm locks and/or easily employed as a new installation.

### II. OBJECTS AND SUMMARY OF THE NEW INVENTION

A first object is to provide a delayed egress lock module that has improved features of simplicity, cost and/or reliability over known prior art devices.

A further object is to provide a delayed egress lock system employing a solenoid drive means which keeps the dead bolt unlocked while the solenoid is normally activated, and temporarily locks the dead bolt when power is cut to the solenoid.

A still further object is for a security door is to integrate a delayed egress sub-system with an existing fire alarm system and to activate the delayed egress sub-system by depression of the push release paddle arm of the dead bolt lock mechanism.

A still further object is to provide lock systems having dead bolts in both the basic push release paddle and the delayed egress system, with initial movement of the push paddle initially activating the delayed egress dead bolt.

Various embodiments of the present invention are defined as follows:

1. A delayed egress paddle door lock system operable with a door that is pivotally mounted in a door frame, comprising:

a. a main lock module having a housing mountable on said door,

b. a strike mountable on said door frame, said main lock module including a lock bolt movable between a normally locked position when engaging said strike and an unlocked position,

c. a push paddle coupled to said lock bolt for driving said lock bolt from its locked position to its unlocked position when said push paddle is pushed,

d. a delayed egress lock module having a housing mountable on said door,

e. a restraining element mountable to said door frame, said delayed egress lock module including:
(1) a locking element movable between its restraining position where it engages said restraining element and restrains said door from being opened, and its release position where it is released from said restraining element,
(2) an electrical drive member which can be activated to move said locking element to its restraining position or to move said locking element to its release position, and

f. a control member including a timer, said control member adapted to:
(1) sense when said push paddle has been pushed to drive said lock bolt to its unlocked position,
(2) activate said electrical drive member to move said locking element to its restraining position to prevent opening said door, and
(3) activate said timer for a predetermined time delay period while said locking element is in its restraining position, and after said time delay, to activate said electrical drive member to move said locking element to its release position, whereby said door becomes openable from said push paddle.
   2. The delayed egress paddle door lock system according to claim 1, where said electrical drive member comprises:

a. a solenoid including a drive element, and

b. a pivotable rocker element having a tail part driven by said solenoid drive element, and a lead part coupled to said restraining element, whereby said drive element, when said electrical drive member is activated by said control member, pivots said rocker whose lead part drives said restraining element to its restraining position, and deactivation of said solenoid by said control member allows said rocker to move said restraining element to its release position, whereby said door becomes openable.

3. The delayed egress paddle door lock system of claim 1 where said locking element comprises a pivotable element having a set of spaced apart projections defining between them a recess into which said restraining element is captured when said locking element is in its restraining position, and said drive member comprises a rod drivable y said rocker lead part to engage and restrain said pivotable element in its restraining position.
4. The delayed egress paddle door lock system of claim 2 where said locking element comprises a pivotable element having a set of spaced apart projections defining between them a recess into which said restraining element is captured when said locking element is in its restraining position, and said drive member comprises a rod drivable y said rocker lead part to engage and restrain said pivotable element in its restraining position.
5. The delayed egress paddle door lock system of claim 2 further comprising a spring biasing said solenoid drive element to its deactivated position, where said locking element is unrestrained.
6. The delayed egress paddle door lock system of claim 1 where said predetermined time delay is in the range of 15-30 seconds.
7. The delayed egress paddle door lock system of claim 1 where said predetermined time delay is in the range of 10-300 seconds.
8. The delayed egress paddle door lock system of claim 1 further comprising (a) an upper lock bolt assembly including a lock bolt and drive unit for said lock bolt mountable on said door above said main lock module, and (b) a lower lock bolt assembly similar to said upper lock bolt assembly and mountable below said main lock module, and (c) and drive members coupling said main lock module drive mechanism to said upper and lower lock bolts, whereby pushing said push paddle will drive said main, upper and lower lock bolts simultaneously to their open positions.
9. A delayed egress paddle door lock system operable with a door that is pivotally mounted in a door frame and includes:

a. a main lock module mounted on said door,

b. a strike mounted on said door frame, said main lock module including a lock bolt movable between a normally locked position when engaging said strike and an unlocked position, and

c. a push paddle coupled to said lock bolt for driving said lock bolt from its locked position to its unlocked position when said push paddle is pushed, said delayed egress paddle door lock system comprising:

d. a housing mountable on said door,

e. a restraining element mountable to said door frame, said delayed egress lock module including:
(1) a locking element movable between its restraining position where it engages said restraining element and restrains said door from being opened, and its release position where it is released from said restraining element,
(2) an electrical drive member which can be activated to move said locking element to its restraining position or to move said locking element to its release position, and

f. a control member including a timer, said control member adapted to:
(i) sense when said push paddle has been pushed to drive said lock bolt to its unlocked position,
(ii) activate said drive member to move said locking element to its restraining position to prevent opening said door, and
(iii) activate said timer for a predetermined time delay period while said locking fork is in its restraining position, and after said time delay, to activate said drive member to move said locking element to its release position, whereby said door becomes openable from said push paddle.
   10. The delayed egress paddle door lock system according to claim 8, where said electrical drive member comprises:

a. a solenoid including a drive element, and

b. a pivotable rocker element having a tail part driven by said solenoid drive element, and a lead part coupled to said restraining element, whereby said drive element, when said electrical drive member is activated by said control member, pivots said rocker whose lead part drives said restraining element to its restraining position, and deactivation of said solenoid by said control member allows said rocker to move said restraining element to its release position, whereby said door becomes openable.

11. The delayed egress paddle door lock system of claim 9 further comprising (a) an upper lock bolt assembly including a lock bolt and drive unit for said lock bolt mountable on said door above said main lock module, and (b) a lower lock bolt assembly similar to said upper lock bolt assembly and mountable below said main lock module, and (c) and drive members coupling said main lock module drive mechanism to said upper and lower lock bolts, whereby pushing said push paddle will drive said main, upper and lower lock bolts simultaneously to their open positions.

These and other advantages of the invention will be further understood and appreciated by those skilled in the art by reference to the following written specification, claims and appended drawings.

### III. BRIEF DESCRIPTION OF THE DRAWINGS

FIG. 1 is a front elevation view of a security door with a paddle arm release triple dead bolt lock system, in combination with a delayed egress system including its delayed lock module,

FIG. 2 is a front elevation view of the new delayed egress lock module of FIG. 1 with the cover removed,

FIG. 3 is a fragmentary top plan view taken along line 3-3 in FIG. 2 showing the release latch in locked delayed egress mode,

FIG. 4 is a fragmentary top plan view taken along line 3-5 in FIG. 2 showing the release latch in unlocked mode, and

FIG. 5 is a schematic circuit diagram for the apparatus of FIG. 1.

The features of the invention will become apparent from the following description of the exemplary embodiments taken in conjunction with the accompanying drawings.

### IV. DETAILED DESCRIPTION OF THE PREFERRED EMBODIMENT

For convenience and clarity in describing these embodiments, similar elements or components appearing in different figures will have the same reference numbers.

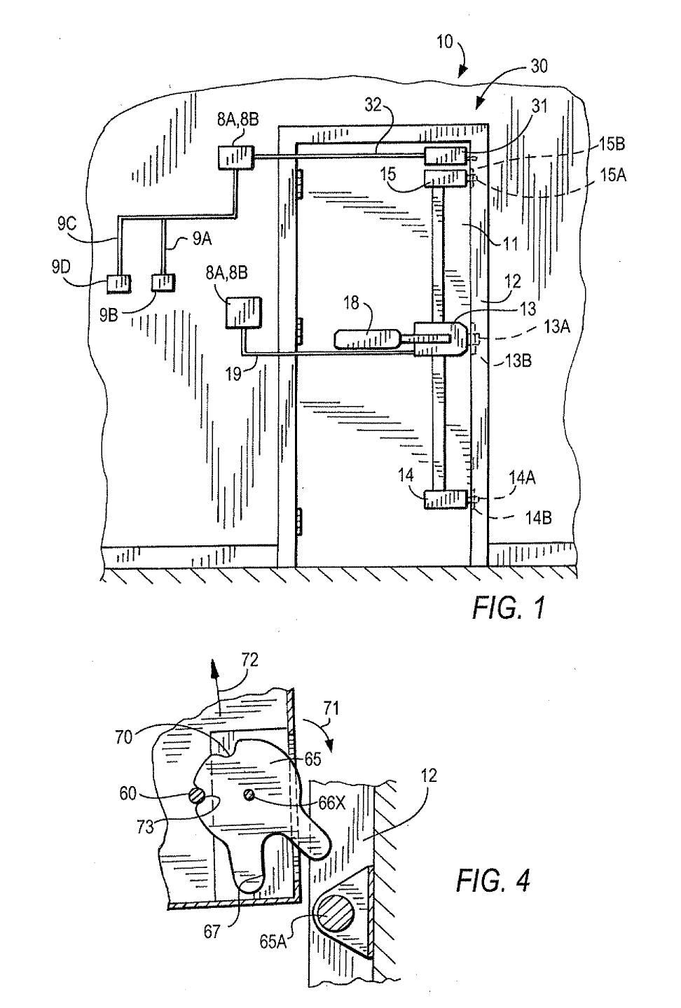

FIG. 1 shows a conventional security door with a three-part dead bolt locking system 10 installed on a security door 11 within a door frame 12. This three-part locking system has: (a) central locking module 13 with its dead bolt 13A for engaging strike plate 13B in door jamb 12A, (b) upper dead bolt module 15 with its dead bolt 15A for engaging strike plate 15B in door jamb 12A, and (c) lower dead bolt module 14 with its dead bolt 14A for engaging strike plate 14B in said door jamb 12A.

Central locking module 13 has engaged thereto its push release paddle 18 and a segment of armored cable 19 for communicating an appropriate signal to controller 8A, 8B when said push paddle is depressed by someone seeking to exit via this security door.

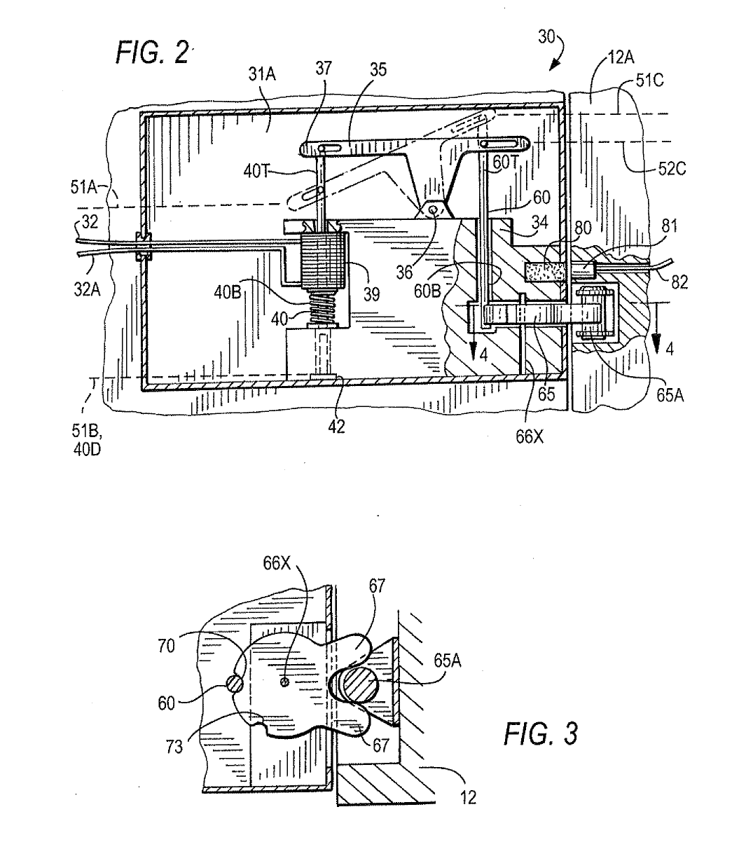

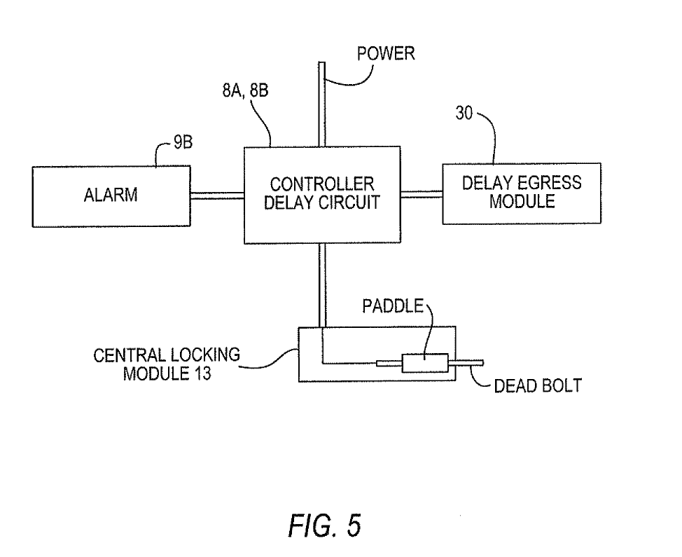

Shown in FIGS. 1 and 2 at the top right portion of the security door is the delay egress locking system 30 which includes delay egress locking module 31 which has a base part 31A and a cover (not shown) for covering the base part. This delayed egress locking module is coupled via armored cable 32 to a controller 8A, 8B shown in FIG. 1 and to cable 9A to an alarm 9B and to cable 9C to a power supply 9D. This module further includes lock fork 65 (see FIGS. 2-4) for engagement with restraining pin 65A mounted to door jamb 12A as seen in FIGS. 3 and 4. Further details of the structure and operation of the delay egress locking module are described with reference to FIGS. 2-4 below. Also seen in FIG. 2 is rocker 35 pivotally mounted on the frame 60 via pivot pin 36. Rocker 35 has foot part 37 and an opposite end head part 38. Above locking fork 65 is a sensor element 80 in frame 60 adjacent a coupling sensor element 81 in door frame 12A and cable 82 cooperating with the controller to signal when the door has been opened.

Beneath and positioned to engage foot part 37 is a solenoid 39 with its drive shaft 40, where top end 40T of the drive shaft is adapted to engage foot part 37 of the rocker, and bottom end 40B of the drive shaft is axially movable until it hits stop 42. Between stop 42 and solenoid 39 is spring 41 which biases drive shaft 40 to its upper position at all times except when solenoid 39 is powered and drives the shaft downward. As will be explained later, in normal operation solenoid 39 is powered, drive shaft 40 is in its downward position, and security door 11 can be opened if paddle 18 is pushed.

Also seen in FIG. 2 at the head end 38 of rocker 35 there is a lock shaft 60 movable axially on frame 34 between its upper and lower positions. Lock shaft 60 has top part 60T and opposite bottom part 60B as seen in solid line in its lower position where end 60B engages restraining fork 65 and prevents it from pivoting, which thereby prevents security door 11 from opening as long as lock shaft 60 is in said down position. In its upper position bottom part 60B is slightly above and disengaged from restricting fork 65.

Locking fork is pivotable about vertical axle 66× seen in FIGS. 2, 3 and 4. FIG. 3 shows locking fork 65 in its closed and locked position where its fingers 67 engage restraining pin 65A mounted in the door jamb, and lock shaft 60 maintains locking fork 65 in that locked mode. As long as locking fork 65 is restrained from rotating, door 11 cannot open. This restraint is what is established during the delayed egress time period and is maintained until locking fork 65 is allowed to rotate following the predetermined time delay, after a person attempts to push the door to open.

As further seen in FIG. 3, lock shaft 60 is in its downward position engaging recess 70, and this engagement is what prevents locking fork 65 from rotating.

As seen in FIG. 4, when locking shaft 60 is moved axially upward until it clears recess 70, then locking fork 65 can rotate clockwise per arrow 71 and the door can be opened in the direction of arrow 72. As further seen in FIG. 4 second recess 73 on fork member 65 can be engaged by pin 60 to maintain fork 65 disengaged from restraining pin 65A so that the delay egress is not operative.

Returning to FIG. 2, the locked and unlocked modes or the corresponding positions of the rocker 35, solenoid drive shaft 40, locking rod 60, will be further described as follows:

a. when rocker 35 is in its tilted position with foot 37 descended as indicated by 51A, this is its normal down and tilted position due to the solenoid being powered and forcing its shaft 40 downward until it hits stop 42. In this mode rocker 35 has its head end 38 in the up position which allows rod 60 to be up, and therefore allows fork member 65 to pivot to its open position shown in FIG. 4 when anyone attempts to exit through the security door. This upward position of the head end 38 of rocker 35 is indicated by mark 51C (in the upper right area of FIG. 2) and the upper position of drive shaft 60 is shown by mark 51B (in the lower left area of FIG. 2). Also, the descended position of solenoid shaft 40 is indicated by mark 40D which corresponds to the down position of rocker 35's foot part 37 shown in its down position 51A (see upper left side of FIG. 2).

b. As seen in FIG. 1 when paddle 18 is pushed, an adjacent switch is depressed sending a signal via cable 19 to controller 20 and to delayed egress controller 8 causing a break in power to solenoid 39 (FIG. 2), and consequently its shaft 40 is released from the solenoid's downward directed force. Spring 41 then automatically drives shaft 40 upward where its top end 40T engages the foot portion 37 of rocker 35 and pivots it clockwise to its horizontal position (see Ref. No. 35) where its head end 38 is seen at position 52C (see right side of FIG. 2). This, as explained earlier, drives shaft 60 downward so that its bottom end 60B engages recess 70 in pivotable fork member 65 and locks that element from rotating, thus barring security door 11 from being opened until the predetermined time delay of 15 to 30 seconds has elapsed. At such time power is returned to the solenoid which drives its shaft 40 downward and allows a person to open the door.

In an alternate version of this invention the delayed egress locking bolt would be normally locked and would be released only after the predetermined time delay following push of the push paddle.

In a still further version this delayed egress lock system is coupled to the fire alarm system of the building so that in case of a fire alarm signal and/or of power failure, the delayed egress locking bolt is automatically released.

While the invention has been described in conjunction with several embodiments, it is to be understood that many alternatives, modifications, and variations will be apparent to those skilled in the art in light of the foregoing description. Accordingly, this invention is intended to embrace all such alternatives, modifications, and variations which fall within the spirit and scope of the appended claims,

1. A delayed egress paddle door lock system operable with a door that is pivotally mounted in a door frame, comprising:
a. a main lock module having a housing mountable on said door,
b. a strike mountable on said door frame, said main lock module including a lock bolt movable between a normally locked position when engaging said strike and an unlocked position,
c. a push paddle coupled to said lock bolt for driving said lock bolt from its locked position to its unlocked position when said push paddle is pushed,
d. a delayed egress lock module having a housing mountable on said door,
e. a restraining element mountable to said door frame, said delayed egress lock module including:
(1) a locking element movable between its restraining position where it engages said restraining element and restrains said door from being opened, and its release position where it is released from said restraining element,
(2) an electrical drive member which can be activated to move said locking element to its restraining position or to move said locking element to its release position, and
f. a control member including a timer, said control member adapted to:
(1) sense when said push paddle has been pushed to drive said lock bolt to its unlocked position,
(2) activate said electrical drive member to move said locking element to its restraining position to prevent opening said door, and
(3) activate said timer for a predetermined time delay period while said locking element is in its restraining position, and after said time delay, to activate said electrical drive member to move said locking element to its release position, whereby said door becomes openable from said push paddle.

2. The delayed egress paddle door lock system according to claim 1, where said electrical drive member comprises:
a. a solenoid including a drive element, and
b. a pivotable rocker element having a tail part driven by said solenoid drive element, and a lead part coupled to said restraining element, whereby said drive element, when said electrical drive member is activated by said control member, pivots said rocker whose lead part drives said restraining element to its restraining position, and deactivation of said solenoid by said control member allows said rocker to move said restraining element to its release position, whereby said door becomes openable.

3. The delayed egress paddle door lock system of claim 1 where said locking element comprises a pivotable element having a set of spaced apart projections defining between them a recess into which said restraining element is captured when said locking element is in its restraining position, and said drive member comprises a rod drivable y said rocker lead part to engage and restrain said pivotable element in its restraining position.

4. The delayed egress paddle door lock system of claim 2 where said locking element comprises a pivotable element having a set of spaced apart projections defining between them a recess into which said restraining element is captured when said locking element is in its restraining position, and said drive member comprises a rod drivable y said rocker lead part to engage and restrain said pivotable element in its restraining position.

5. The delayed egress paddle door lock system of claim 2 further comprising a spring biasing said solenoid drive element to its deactivated position, where said locking element is unrestrained.

6. The delayed egress paddle door lock system of claim 1 where said predetermined time delay is in the range of 15-30 seconds.

7. The delayed egress paddle door lock system of claim 1 where said predetermined time delay is in the range of 10-300 seconds.

8. The delayed egress paddle door lock system of claim 1 further comprising (a) an upper lock bolt assembly including a lock bolt and drive unit for said lock bolt mountable on said door above said main lock module, and (b) a lower lock bolt assembly similar to said upper lock bolt assembly and mountable below said main lock module, and (c) and drive members coupling said main lock module drive mechanism to said upper and lower lock bolts, whereby pushing said push paddle will drive said main, upper and lower lock bolts simultaneously to their open positions.

9. A delayed egress paddle door lock system operable with a door that is pivotally mounted in a door frame and includes:
a. a main lock module mounted on said door,
b. a strike mounted on said door frame,
said main lock module including a lock bolt movable between a normally locked position when engaging said strike and an unlocked position, and
c. a push paddle coupled to said lock bolt for driving said lock bolt from its locked position to its unlocked position when said push paddle is pushed, said delayed egress paddle door lock system comprising:
d. a housing mountable on said door,
e. a restraining element mountable to said door frame, said delayed egress lock module including:
(1) a locking element movable between its restraining position where it engages said restraining element and restrains said door from being opened, and its release position where it is released from said restraining element,
(2) an electrical drive member which can be activated to move said locking element to its restraining position or to move said locking element to its release position, and
f. a control member including a timer, said control member adapted to:
(i) sense when said push paddle has been pushed to drive said lock bolt to its unlocked position,
(ii) activate said drive member to move said locking element to its restraining position to prevent opening said door, and
(iii) activate said timer for a predetermined time delay period while said locking fork is in its restraining position, and after said time delay, to activate said drive member to move said locking element to its release position, whereby said door becomes openable from said push paddle.

10. The delayed egress paddle door lock system according to claim 8, where said electrical drive member comprises:
a. a solenoid including a drive element, and
b. a pivotable rocker element having a tail part driven by said solenoid drive element, and a lead part coupled to said restraining element,
whereby said drive element, when said electrical drive member is activated by said control member, pivots said rocker whose lead part drives said restraining element to its restraining position, and deactivation of said solenoid by said control member allows said rocker to move said restraining element to its release position, whereby said door becomes openable.

11. The delayed egress paddle door lock system of claim 9 further comprising (a) an upper lock bolt assembly including a lock bolt and drive unit for said lock bolt mountable on said door above said main lock module, and (b) a lower lock bolt assembly similar to said upper lock bolt assembly and mountable below said main lock module, and (c) and drive members coupling said main lock module drive mechanism to said upper and lower lock bolts, whereby pushing said push paddle will drive said main, upper and lower lock bolts simultaneously to their open positions.
